(19) United States
(12) Patent Application Publication
(10) Pub. No.: US 2009/0327181 A1
(43) Pub. Date: Dec. 31, 2009

(54) BEHAVIOR BASED METHOD AND SYSTEM FOR FILTERING OUT UNFAIR RATINGS FOR TRUST MODELS

(76) Inventors: Sung-Young Lee, Seongnam-si (KR); Young-Koo Lee, Suwon-si (KR); Wei Wei Yuan, Yongin-si (KR)

Correspondence Address: SHERR & VAUGHN, PLLC, 620 HERNDON PARKWAY, SUITE 320, HERNDON, VA, 20170, US

(21) Appl. No.: 12/494,446

(22) Filed: Jun. 30, 2009

(30) Foreign Application Priority Data
Jun. 30, 2008 (KR) 10-2008-0062976

(51) Int. Cl. G06N 3/08; G06Q 10/00; G06F 15/18

(52) U.S. Cl. 706/20; 705/10; 705/7; 706/25

(57) ABSTRACT

Disclosed is a behavior-based method which uses each rater's rating behaviors as the criterion to judge unfair ratings. A behavior refers to the action that a rater gives certain rating under specific context. The behavior-based method regards the rating given by a rater with abnormal behavior as an unfair rating, where abnormal behavior is recognized by comparing a rater's current behavior with his behavior history.

### BACKGROUND OF THE INVENTION

1. Field of the Invention

The present invention relates to a behavior-based method and system for filtering out unfair ratings for trust models.

2. Background of the Related Art

One fundamental challenge for trust models is how to avoid or reduce the influence of unfair ratings since one agent's trust has to base on ratings from other agents when interacting with unknown agents.

Different approaches have been proposed to handle unfair ratings for trust models. The proposed methods can be grouped into the statistical method category and the weighted method category:

1) The statistical method, which assumes that a statistical analysis reveals the unfair ratings:

Dellarocas [“Building Trust Online: The Design of Robust Reputation Reporting Mechanisms for Online Trading Communities”, in G. Doukidis, N. Mylonopoulos, N. Pouloudi, (eds.), Information Society or Information Economy? A combined perspective on the digital era: Idea Book Publishing, 2004] proposes a combined approach using controlled anonymity and cluster filtering to filter out the unfair ratings. In particular, controlled anonymity is used to avoid unfairly low ratings and negative discrimination, and cluster filtering is used to reduce the effect of unfairly high ratings and positive discrimination. Ratings in the lower rating cluster are considered as fair ratings. Ratings in the higher rating cluster are considered as unfairly high ratings, and therefore are excluded or discounted.

Jøsang and Indulska [“Filtering out unfair ratings in Bayesian reputation systems”, ICFAIN Journal of Management Research, vol. 4, no. 2, pp. 48-64, 2005.] propose beta reputation system (BRS) to estimates reputations of provider agents using a probabilistic model. Based on the idea that unfair ratings have a different statistical pattern than fair ratings, BRS uses a statistical filtering technique, in particular, an iterated filtering algorithm based on the Beta Distribution, to exclude unfair ratings.

Weng et al. [“An entropy-based approach to protecting rating systems from unfair testimonies”, IEICE Transactions on Information and Systems, VOL. E89-D; NO. 9; PAGE. 2502-2511, 2006.] propose an entropy-based method in the context of Beta Rating System to filter out unfair ratings. In particular, the proposed filtering method is: if, compared with the quality of the current majority opinion, which is generated by aggregating existing fair ratings, a new rating shows a significant quality improvement or downgrade, the rating is away from the majority opinion. Thus it is considered as a possible unfair rating and it would be discarded.

2) The weighted method, which assumes that ratings from users with low reputation are probably unfair:

Google's PageRank [A. Clausen, The cost of attack of PageRank, In Proc. of The Intl. Conf. on Agents, Web Technologies and Internet Commerce (IAWTIC'2004), pp. 77-90, 2004.] is a famous approach that selects reliable pages based on each page's weight, which is calculated by a link analysis algorithm. In particular, it uses the hyperlink structure of the Web to build a Markov chain with a primitive transition probability matrix. The irreducibility of the chain guarantees that the long-run stationary vector, known as the PageRank vector, exists. It is well-known that the power method applied to a primitive matrix will converge to this stationary vector. Further, the convergence rate of the power method is determined by the magnitude of the subdominant eigenvalue of the transition rate matrix.

Ekstrom and Bjornsson [“A rating system for AEC e-bidding that accounts for rater credibility”, In Proc. of the CIB W65 Symposium, pages 753-766, 2002.] propose a scheme and design a tool called TrustBuilder, which weights ratings by rater credibility, for rating subcontractors in the Architecture Engineering Construction (AEC) industry. TrustBuilder uses two types of information that can support the evaluation of rater credibility: direct knowledge about the rater, and knowledge about the rater's organization. This credibility weighted rating tool follow a 3-step process: 1. Credibility Input. 2. Calculation of Rater Weights. 3. Display Ratings and Rater Information.

Buchegger and Le Boudec [“A Robust Reputation System for Mobile Ad-hoc Networks”, Proc. of P2PEcon, pp. 1321-1330, 2004] propose a scheme based on a Bayesian reputation engine and a deviation test to classify raters' Trustworthiness. In this approach, every node maintains a reputation rating and a trust rating about other nodes that it cares about. The trust rating for a node represents how likely the node will provide true advice. The reputation rating for a node represents how correctly the node participates with the node holding the rating. A modified Bayesian approach is developed to update both the reputation rating and the trust rating. Evidence is weighted according to its order of being collected.

Each category of related work has its own advantages and disadvantages when dealing with different cases as shown in FIG. 1: the statistical method can only filter out unfair ratings if unfair ratings are minority, no matter the ratings are given by raters acted honest or maliciously; on the other hand, the weighted method can only filter out unfair ratings given by raters who acted maliciously, no matter the proportion of unfair ratings is low or high.

### SUMMARY OF THE INVENTION

Accordingly, the present invention has been made by taking the advantages of existing methods but avoiding their limitations. It is the objective of the present invention to contribute to an approach which can filter out unfair ratings for trust models regardless of the proportion of unfair ratings and the characteristics of agents who give ratings. This is achieved by proposing a novel behavior-based method which regards the ratings given by the agents with abnormal behaviors as unfair.

### BRIEF DESCRIPTION OF THE DRAWINGS

FIG. 1 shows existing method's ability on filtering out unfair ratings in different cases.

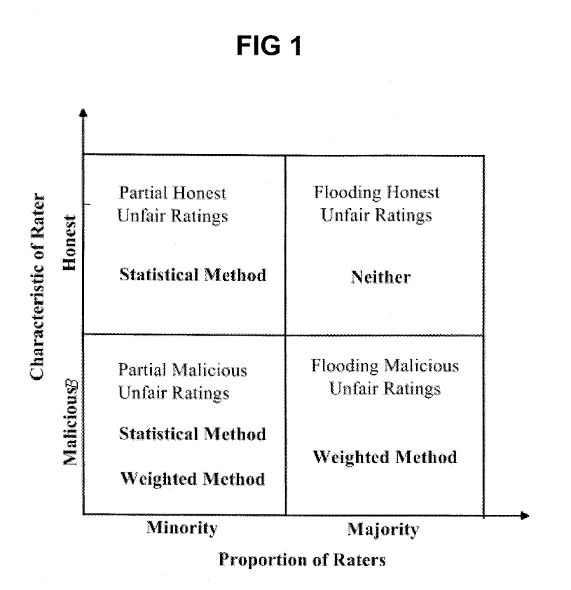

FIG. 2 illustrates a flow chart showing behavior-based method to filter out unfair ratings for trust models according to an embodiment of the present invention.

### DETAILED DESCRIPTION OF THE INVENTION

The present invention provides a behavior-based method which uses each rater's rating behaviors as the criterion to judge unfair ratings. A behavior refers to the action that a rater gives certain rating under specific context. The behavior-based method of the present invention regards the rating given by a rater with abnormal behavior as an unfair rating, where abnormal behavior is recognized by comparing a rater's current behavior with his behavior history.

The key idea for the present invention is: each rater has its own inherent judging rule on rating giving, and all ratings given by one rater are referred to the same judging rule. Therefore one rater's behavior is usually similar as its previous behaviors in similar contexts, i.e., a rater usually gives similar ratings as what he gave previously in similar contexts. Hence if a rater's behavior is very different from his previous behaviors, i.e., the rater gives a very different rating compared with his previous ones under similar contexts, the rating given by this very different behavior is regarded as an unfair rating.

To use the behavior-based method, it is essential to learn each rater's judging rule on rating giving since it is the criterion to measure each rater's behaviors. Yet a rater's judging rule is not everlasting, it sometimes may change due to various reasons, e.g. due to the change of its acceptance level to the environment, a rater now only gives positive ratings to ratees whose past interactions with it are more than 80% successful instead of previous one, 60%. Hence it is necessary to update learned judging rules of raters continuously to catch up the latest trends.

To achieve this, incremental learning neural networks are used to learn each rater's judging rule on rating giving. The reason why incremental learning neural networks are used is that they can update an existing classifier in an incremental fashion to accommodate new data without compromising classification performance on old data, which enables us to update each rater's judging rule from time to time. Furthermore, in real scenarios, the data available for training are not always enough to reveal each rater's entire judging rule, and incremental learning neural networks enable us to update the learned judging rules when more data become available in small batches over a period of time.

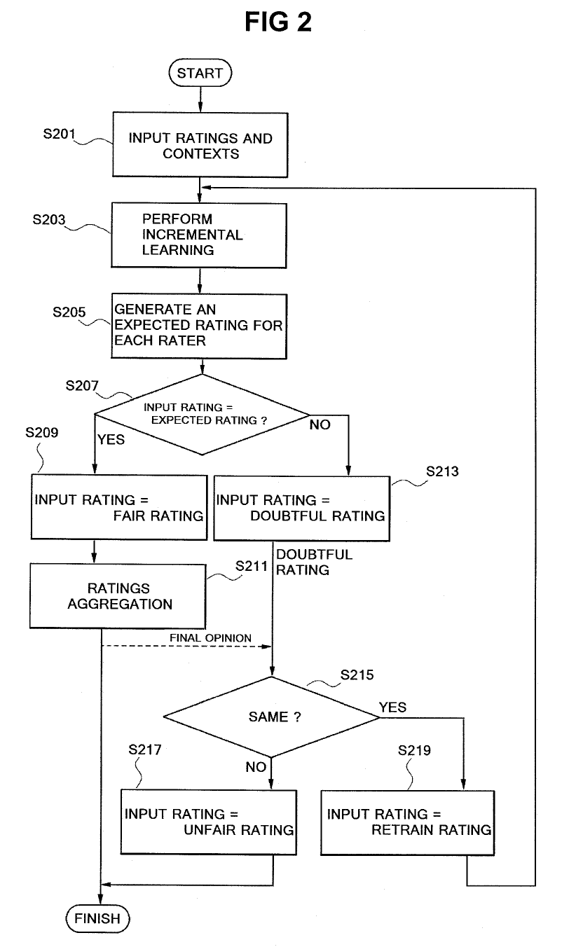

FIG. 2 illustrates a flow chart showing behavior-based method to filter out unfair ratings for trust models according to an embodiment of the present invention.

Ratings from several raters and the corresponding contexts are inputted at step S201. Ratings are related to the contexts under which they were given since ratings along with the corresponding contexts are reflecting different raters' behaviors on rating giving. A context is a set of attributes and their instantiated values about an environment. Contexts may be provided by a Context-Aware Middleware. The Context-aware Middleware is a middleware that derives contexts using many data sources such as sensors, databases, etc, and notifies contexts to applications.

Next, raters with doubtful behaviors (doubtful raters) are distinguished from raters with fair behaviors (fair raters) using the following steps.

Incremental learning is performed on the inputted ratings and contexts in step S203. As mentioned before, it is necessary to update learned judging rules of raters continuously to catch up the latest trends. In the present invention, incremental learning neural networks are used to learn each rater's judging rule on rating giving. The reason why incremental learning neural networks are used is that they can update an existing classifier in an incremental fashion to accommodate new data without compromising classification performance on old data, which enables us to update each rater's judging rule from time to time.

Then, an expected rating for each rater is generated in step S205. The expected rating is the rating that a rater is expected to give under the given context based on its judging rule. Cascade-Correlation architecture may be used to learn the raters' judging rules based on the raters' behavior history. Cascade-Correlation is a supervised learning algorithm for incremental learning neural networks developed by Scott Fahlman. Instead of adjusting the weights in a network of fixed topology, Cascade-Correlation begins with a minimal network, then automatically trains and adds new hidden units one by one, creating a multi-layer structure. Once a new hidden unit has been added to the network, its input-side weights are frozen. This unit then becomes a permanent feature-detector in the network, available for producing outputs or for creating other, more complex feature detectors. The Cascade-Correlation architecture is trained by the raters' behavior history.

To distinguish the raters with doubtful behaviors from the raters with fair behaviors, the expected ratings are compared with the original ratings given by raters (step S207). If the rating given by a rater is different from its expected rating, this rater is regarded as a doubtful rater and this rating as a doubtful rating (S213) since its current behavior on rating giving is different from previous, i.e. the rater has doubtful behavior. Otherwise, if the rating given by a rater is the same as its expected rating, this rater is regarded as a fair rater and this rating as a fair rating (S209).

Not all doubtful ratings are unfair. This is due to two reasons: (1) the raters' judging rules have been changed. This kind of situation is reasonable since all things are always in movement and raters may adjust their judging rules as time goes by; (2) the currently neural network is not enough to reflect some raters' judging rules since the Cascade-Correlation architecture begins with a minimal network and the knowledge on raters' rules are incrementally increased. Ratings which are doubtful but not unfair, along with the contexts under which they were given, need to be sent back to retrain the Cascade-Correlation architecture to catch up the raters' lasted judging rules. And we call these ratings retrain ratings.

The truster's final trust decision on the ratee is made using ratings given by the fair raters in step S211. The decision results are used to classify ratings given by doubtful raters into unfair ratings and retrain ratings as follows.

Doubtful ratings are compared with the truster's final trust decision on the ratee in step S215. If a doubtful rating is different from the truster's final trust decision on the ratee, it regarded as an unfair rating (S217). The rater that gives unfair ratings is called an unfair rater, and its behavior on rating giving is regarded as unfair behavior. Otherwise, if a doubtful rating is the same as the truster's final trust decision on the ratee, it is regarded as a retrain rating (S219). The rater that gives retrain ratings is called a retrain rater. Retrain ratings are sent back to step S203 to reflect the retrain raters' current judging rules.

The foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be broadly limited only by the following claims.

1. A method for filtering out unfair ratings based on behaviors, comprising:
receiving ratings and contexts under which the ratings were given;
classifying raters into fair raters with fair behavior and doubtful raters with doubtful behavior using the ratings and contexts, ratings from the fair raters being fair ratings and ratings from the doubtful raters being doubtful ratings;
calculating a truster's final trust decision on the ratee using ratings given by the fair raters; and
regarding each of the doubtful raters as an unfair rater if the received rating is different from the truster's final trust decision, and otherwise as a retrain rater, and regarding the rating from the unfair rater as an unfair rating.

2. The method of claim 1, wherein the classifying includes:
calculating an expected rating for each of the raters who gave the ratings for the context based on its judging rule;
comparing the expected rating with the received rating for each rater; and
regarding each of the raters as a doubtful rater if the expected rating is different from the received rating, and otherwise as a fair rater and regarding the rating from the fair rater as a fair rating and the rating from the doubtful rater as a doubtful rating.

3. The method of claim 2, wherein the judging rule is learned using incremental learning neural network.

4. The method of claim 3, further comprising retraining the judging rule of the retrain rater by inputting the received rating of the retrain rater into the incremental learning neural network.

5. The method of claim 4, wherein Cascade-Correlation architecture is used for the incremental learning neural network.

6. A system for filtering out unfair ratings based on behaviors, comprising:
means for receiving ratings and contexts under which the ratings were given;
means for classifying raters into fair raters with fair behavior and doubtful raters with doubtful behavior using the ratings and contexts, ratings from the fair raters being fair ratings and ratings from the doubtful raters being doubtful ratings;
means for calculating a truster's final trust decision on the ratee using ratings given by the fair raters; and
means for regarding each of the doubtful raters as an unfair rater if the received rating is different from the truster's final trust decision, and otherwise as a retrain rater, and regarding the rating from the unfair rater as an unfair rating.

7. The system of claim 6, wherein the means for classifying raters includes:
means for calculating an expected rating for each of the raters who gave the ratings for the context based on its judging rule;
means for comparing the expected rating with the received rating for each rater; and
means for regarding each of the raters as a doubtful rater if the expected rating is different from the received rating, and otherwise as a fair rater and regarding the rating from the fair rater as a fair rating and the rating from the doubtful rater as a doubtful rating.

8. The method of claim 7, wherein the judging rule is learned using incremental learning neural network.

9. The method of claim 8, further comprising means for retraining the judging rule of the retrain rater by inputting the received rating of the retrain rater into the incremental learning neural network.

10. The method of claim 9, wherein Cascade-Correlation architecture is used for the incremental learning neural network.
